(19) United States
(12) Patent Application Publication
(10) Pub. No.: US 2004/0267849 A1
(43) Pub. Date: Dec. 30, 2004

(54) [BAND PASS FILTER]

(76) Inventors: DAVID SHIUNG, TAINAN CITY (TW); WUNCHI LIN, ILAN (TW); VICKY CHANG, CHANGHUA CITY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,169

(22) Filed: Jun. 30, 2003

(51) Int. Cl. G06F 17/10

(52) U.S. Cl. 708/300

(57) ABSTRACT

A band pass filter (BPF) for extracting a desired frequency band from an input signal that is represented in a sequence of data stream. Breaking through a traditional Infinite-duration Impulse Response (IIR) or Finite Impulse Response (FIR) filter design technologies, by using a difference of an input signal and a delayed version of the input signal, the present invention provides another way to make a band pass filter that greatly reduces the complexity, the costs, the power consumption, the design area required of an IIR or a FIR based band pass filter.

### BACKGROUND OF INVENTION

1. Field of the Invention

The present invention relates to a novel way in realizing a band pass filter (BPF), and more particularly, to a use of a shift register and a subtracter achieving a functionality of a band pass filter. Herein, an output of the BPF of the present invention is obtained by subtracting a value in the last register from a value in the first register of the shift register.

2. Description of the Prior Art

A wide range of band pass filters and methods is known for extracting a desired frequency band from an input signal. Typically, such band pass filters relies upon Infinite-duration Impulse Response (IIR) or Finite Impulse Response (FIR) filter design technologies to achieve a frequency band extracting purpose. A FIR, and an IIR based band pass filter are depicted in FIG. 2, and FIG. 3 respectively. In FIG. 2, a generic FIR based band pass filter is given, and in FIG. 3, a practical use of an IIR based band pass filter is depicted. In IIR filter architecture 300, not only two sets of coefficients aX, bX need to be determined via complex mathematical calculations, but also a number of adders and multipliers are required to operate among these coefficients and input data to get the filter output. In FIG. 3, the adders are represented by 310, 311, 312, 313, and the multipliers are represented by 320, 321, 323, 324. The more input lines the more hardware costs; the more adders and multipliers the more power consumption and larger space consumed to build the devices. Similar to the FIR filter architecture 200, a set of coefficients, a1 to aN, a number of adders 210 and multipliers 220 make a not only costly but also complex layout of a BPF comparing with the present invention that uses a shift register and an subtracter to form a BPF.

In FIG. 2, an input signal 230 is fed to a serial-in parallel-out shift register. Every register in the shift register 201 is connected to a multiplier that multiplies a preset coefficient aN to a content holding in the register. An output of the multiplier feeds to an adder, and the adder sums up a result of the multiplier and a result of a previous adder along the shift register. By following this connection scheme, the adders are connected one after another to form an output terminal 240 at the last adder. Clearly, in addition to a serial-in parallel-out shift register, a set of coefficients, a number of multipliers, and a number of adders are required for a FIR based band pass filter.

In FIG. 3, a practical example of an IIR based band pass filter is given. Note that a shift register is lined up upright; blocks 301, 302 represent an entrance-end register and an exit-end register of the shift register respectively. An input signal is fed to an adder 310; after adding up with a value from adder 311, the adding results are stored in the entrance-end register 301 of the shift register, and are fed to a multiplier 320 to get multiplied by a coefficient b0. The multiplied results then are fed to an input of an adder 312. The adder 312 adds up a value from the multiplier 320 and a value from an adder 313 to obtain an output of an IIR based band pass filter.

By responding to a shift register clock pulse, the input signal goes through the shift register sequentially. After a shift register clock pulse, data stored in the entrance-end register 301 are moved to the exit-end register 302, and next data are pumped into the entrance-end register. A value stored in the entrance-end register 301 is fed to a multiplier 321, and an adder 313. The multiplier 321 multiplies the value from register 301 by an input coefficient a1, and gives its results to an adder 311. The adder 313 adds up the value from register 301 and a value from a multiplier 324, and gives its results to the adder 312. Continuing the calculation down to next level, a value stored in register 302 is fed to multipliers 323 and 324. The multiplier 323 multiplies the value from register 302 by an input coefficient a2, and gives its results to the adder 311. The multiplier 324 multiplies the value from register 302 by an input coefficient b2, and gives its results to the adder 313. After this looping around operation, an output of the IIR based band pass filter is obtained.

By comparing with the present invention, a use of a shift register and a subtracter to form a band pass filter greatly reduces the calculation complexity, an integrated circuit (IC) fabrication complexity and costs of a regular IIR or FIR based band pass filter.

### SUMMARY OF INVENTION

The present invention is directed to an improved band pass filter architecture and method that greatly reduce the complexity, costs, space required, and power consumption for the implementation of a prevalent IIR, or FIR based band pass filter. The present invention identifies that a desired frequency band of an input signal that is represented in a data stream can be obtained by subtracting a delayed copy of the input data stream from the input data stream. A delayed time period of the input data stream determines a desired frequency band that needs to be extracted from the input data stream. The delayed time period can be calculated by a ratio of a input signal sampling rate to two times of a target desired frequency.

If a shift register is used for delaying the input data stream, the number of registers inside the shift register is determined by adding one to an integer part of a ratio of a input signal sampling rate to two times of a target desired frequency. Note that one is added to the integer part of the ratio; however, the number of time unit delayed between the data holding in the first and the last registers of the shift register is never changed. The delayed time units are exactly equal to the integer part of the ratio of the input signal sampling rate to two times of the target desired frequency that measured by the shift register synchronization clock.

In one embodiment there is provided a band pass filter that comprises a shift register and an arithmetic subtracter as depicted in FIG. 1 to achieve a band pass filter functionality. The arithmetic subtracter subtracts a value holding in the last register from a value holding in the first register of the shift register to form an output of the band pass filter. The number of registers used in the shift register is addressed in the previous paragraph.

In another embodiment, there is provided a method for obtaining a desired frequency band. The method comprises: receiving a series of data according to a time frame; and according to the time frame, sequentially reporting a difference between a “currently” received data and a “previously” received data to obtain an output of the method. Note that the “currently” and “previously” in the above sentence represents a fixed time period between the two received data. In a related embodiment, the previously received data is determined by a calculation of a ratio of a input signal sampling rate to two times of a target desired frequency. In another related embodiment, during a boundary condition of the band pass filter method, a beginning of the method or an ending of the method, zeros are assigned to the ends of the data series. For instance, when the series of data is not yet old enough to be qualified as the “previously” received data, zero is assigned to the previously received data for the method to take off from the currently received data. On the other hand, when the last data of the data series passes the current time frame, zeros are assigned to the currently received data for the method to subtract the “previously” received data.

In yet another embodiment, there is provided a method for carrying out a band pass filter, the method comprising: providing a number of registers coupled in cascade to form a shift register, having a first register and a last register, wherein each register has a storage capacity with at least one bit; and computing a difference of contents stored in the first register and the last register as an output of the method in a clock frame.

As a summary, by carefully choosing a delayed time period of an input data stream, the present invention provides a feasible band pass filter architecture that greatly reduces the costs, the complexity, the power consumption, and the space required for a regular IIR, or FIR based band pass filter.

### BRIEF DESCRIPTION OF DRAWINGS

The invention will be more readily understood by reference to the following description, taken with the accompanying drawings.

FIG. 1 is a band pass filter of a preferred embodiment of the present invention.

FIG. 2 is a FIR based band pass filter.

FIG. 3 is an IIR based band pass filter.

FIG. 4 is an amplitude response of a band pass filter of a preferred embodiment of the present invention.

FIG. 5 is a phase response of a band pass filter of a preferred embodiment of the present invention.

FIG. 6 is an amplitude response of an IIR based band pass filter.

FIG. 7 is a phase response of an IIR based band pass filter.

FIG. 8 is a flow chart diagram representing a band pass filtering method of the present invention.

FIG. 9 is a flow chart diagram representing another band pass filtering method of the present invention.

### DETAILED DESCRIPTION

The present invention is described below in the context of a “band pass filter.” The reference to “band pass filter” is intended to refer to a use of a difference of an input signal and a time shift version of the input signal to extract a desired frequency band from the input signal. Many advantages can be identified by the use of the present invention to build a band pass filter. For instance, the power consumption, the complexity, the costs, and the device area required for a regular band pass filter are greatly reduced by use of the band pass filter architecture of the present invention. From a consumption of device area point of view, it is well known by those of ordinary skill in the art that the area and the number of logic gates required for an adder or a subtracter is much less than a multiplier required.

A wide range of band pass filters is built upon IIR or FIR band pass filter architectures that use not only adders and multipliers but also a set of coefficients to achieve a frequency band extracting functions. Both input lines for coefficients and hardware layout for adders and multipliers increase complexity and power consumption of a band pass filter. As a consequence, a built up heat due to power consumption of the band pass filter also causes more possible hardware failures during the hardware operation. On the other hand, as a contrast, to implement the present invention in hardware, a shift register with a predetermined length and an arithmetic subtracter are enough to achieve a functionality of a band pass filter.

The present invention is also feasible for software implementation. By use of the present invention in software, less coding, less variables, and less software overhead bring up the performance of a software band pass filter application. The present invention can be realized not only in computer hardware or computer software but also in an analog circuit as a user wishes. There are three preferred embodiments of the present invention are addressed as follows; however, the present invention is not limited to these preferred embodiments.

The first preferred embodiment of the present invention uses a shift register and an arithmetic subtracter to form a band pass filter 100 as depicted in FIG. 1. The shift register 101 is constructed by a plurality of registers coupled in cascade; therefore, a data entrance end 104 and a data exit end 106 of the shift register is provided. The arithmetic subtracter 110 subtracts a value holding in the exit end 106 register from a value holding in the entrance end 104 register to produce an output of the band pass filter 140. A detail of the band pass filter functions as follows.

At the beginning, zeros are preset to all registers in the shift register before the system is ready to do its job. An input signal that is represented by a sequence of data stream is fed to an input terminal 130 of the band pass filter 100. By responding to a synchronization clock that is connected to the shift register 101, the input signal is shifted into the shift register 101 from the entrance end 104. As time goes by, the input signal is moving through the shift register 101, and leaving the shift register 101 via the exit end 106. Note that the shift register 101 always keeps a segment of the input signal as the input signal sliding through, and as time goes by, the exit end 106 register is holding a delayed copy of data in the entrance-end register 104.

By carefully choosing the length of the shift register 101, thereby the delayed time period of the input signal occurring between the entrance end 104 and the exit end 106 of the shift register 101, a desired frequency band is extracted from the input signal by subtracting the delayed input signal from the input signal. As a result, as depicted in FIG. 1, an output 140 of the band pass filter 100 is obtained.

The delayed time period of the input signal can be determined by the following formula: Delayed Time Period=fs/2fo, (Eqn. 1) where: fs is a sampling rate of the input signal; and fo is a desired frequency band that needs to be extracted from the input signal. While the length of the shift register can be determined by the following formula: The number of registers need=[fs/2fo]+1, (Eqn. 2) same as in Eqn. 1, where fs, and fo represent an input signal sampling rate, and a desired frequency band respectively. Note that one is added to the integer part of the ratio of fs/2fo; however, the number of time unit delayed between the data holding in the first and the last registers of the shift register is never changed. The delayed time units are exactly equal to the integer part of the ratio of the input signal sampling rate to two times of the target desired frequency. The delayed time units are measured by and in accordance with the shift register synchronization clock.

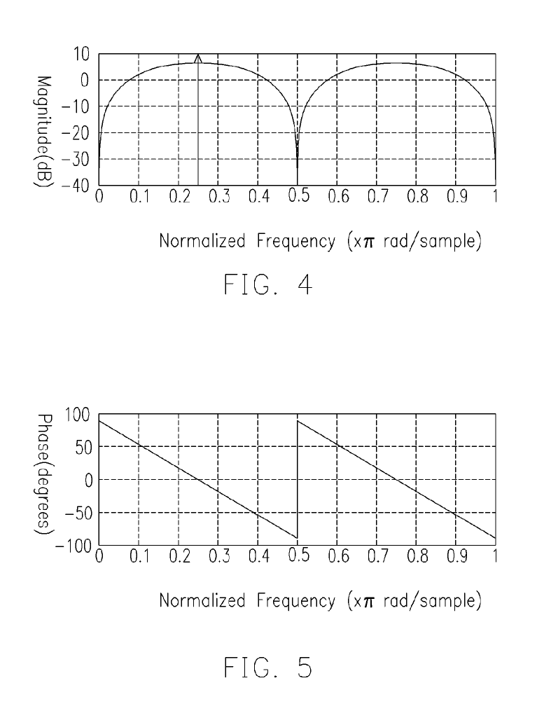

An exercise of the first preferred embodiment of the present invention is as follows. An input signal sampling rate of 100 kHz data stream is fed into the input terminal 130 of the band pass filter 100 depicted in FIG. 1. A desired frequency band for example centered at 12.5 kHz is aimed to be extracted from the 100 kHz sampling rate data stream. According to Eqn. 2, the number of registers need to achieve the goal is 100 kHz divided by 2(12.5 kHz) plus 1 that gives 5 registers. A shift register of 5-register length and an arithmetic subtracter are configured as a band pass filter as demonstrated in FIG. 1 to accomplish a band pass filter function on an input signal of 100 kHz sampling rate data stream to have output results depicted in FIG. 4 and FIG. 5.

In FIG. 4, the horizontal axis represents a normalized frequency band from 0 to 1, and the vertical axis represents a magnitude of the output data in dB unit. In FIG. 4, along the horizontal axis, 1 represents a 50 kHz signal that has a sampling rate of 100 kHz. Clearly, the target frequency 12.5 kHz is located at 0.25 scale as depicted by an upright arrow in FIG. 4 where is the passing frequency centered. The other passing frequency centered at 0.75 scale that is where 37.5 kHz signal resides. Instead of a single frequency band, the band pass filter extracts two frequency bands from the input signal; one is the target frequency band, and the other is a mirror of the target frequency band. So long as an input signal doesn't contain a signal frequency in a mirror of the target frequency band, the band pass filter will extract exactly a user desired frequency band from the input signal. FIG. 5 is the band pass filter output phase diagram.

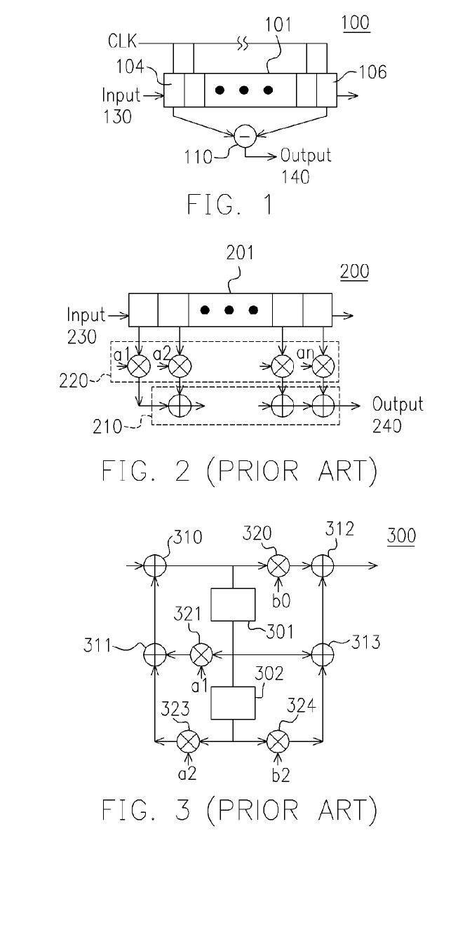

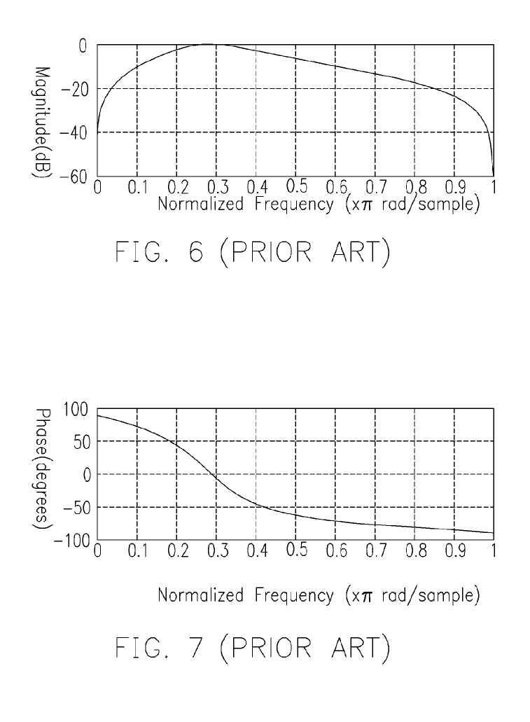

FIG. 6, and FIG. 7 represent an output result of an IIR based band pass filter depicted in FIG. 3. The same input signal data stream (100 kHz sampling rate) and the same target frequency (12.5 kHz) are applied to the IIR based band pass filter. Note that to a compatible result, the IIR based band pass filter uses 4 multipliers, 4 adders, 2 registers, and a set of coefficients, b0, a1, a2, and b2. The values that assigned to the coefficients are b0=0.24523727525279, a1=0.93293803467052, a2=−0.50952544949443, and b2=−0.24523727525279. Comparing to the compatible results, the band pass filter of the preferred embodiment of the present invention uses only a shift register of 5-registe length, a subtracter, and no input coefficients that greatly reduces the complexity, costs, power consumption, and space required in the IIR based band pass filter. There will fall into a similar case if FIR based band pass filter is used as depicted in FIG. 2. A set of coefficients and multipliers 220, and a set of adders 210 are not avoidable in a FIR based band pass filter design.

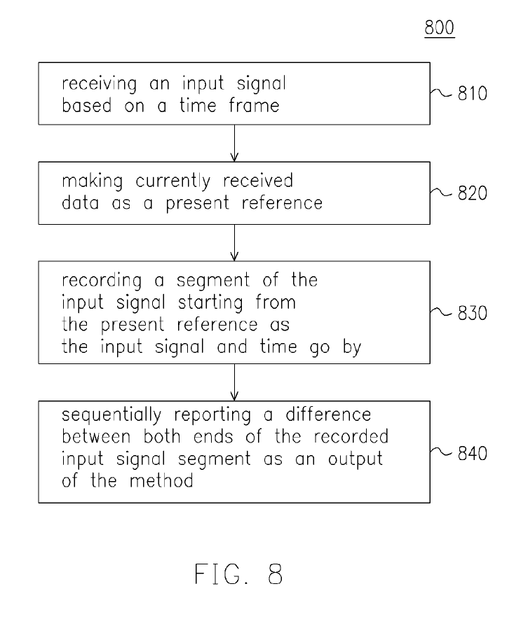

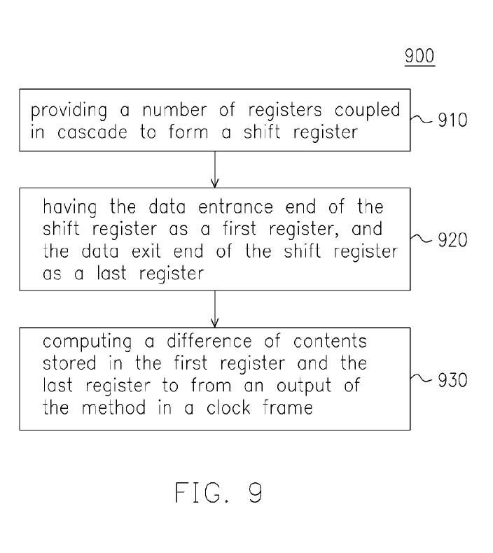

The second preferred embodiment of the present invention presents a method of obtaining a desired frequency band from an input signal as depicted in FIG. 8. In FIG. 8, the method is demonstrated by a flow chart diagram (800). The method first receives the input signal based on a time frame (810). Then, the method marks currently received data as a present reference (820) and records a segment of the input signal starting from the present reference and on as the input signal and time go by (830); thereby, the sequence of the recorded input signal segment provides a starting end and an ending end of the segment. Finally, the method sequentially reports a difference between the starting end and the ending end of the recorded input signal segment to obtain an output of the method based on the time frame (840).

The method addressed above, a length of the recorded input data segment is determined by a ratio of a half of a sampling rate of the input signal to a target desired frequency of the method. Also, at a boundary condition of the method, a beginning or an ending of the method, zeros are inserted to both ends of the input data sequence.

The third preferred embodiment of the present invention presents another method of obtaining a desired frequency band from an input signal. The method is depicted in a flow chat diagram as presented in FIG. 9. First, the method provides a number of registers coupled in cascade to form a shift register (910); thereby, a first register and a last register are identified at a data entrance end and a data exit of the shift register (920). Each register has a storage capacity of at least one bit of digital data. Finally, the method computes a difference of contents stored in the first register and the last register to form an output of the method in a clock frame (930).

In the method addressed in the last preferred embodiment of the present invention, the number of registers is determined by adding one to an integer part of a ratio of a half of the input signal sampling rate to a target desired frequency of the method. The difference of contents stored in the first and last registers is calculated by adding a content of the first register and a negative content of the last register to form an output of the method in the clock frame. Also, a register in the shift register of the method can be use to store digital data or numeric data. Note that the method is feasible to be implemented by computer hardware or computer software, and the clock frame in the method is a shift register synchronization clock.

It will be apparent to those skilled in the art that various modifications and variations can be made to the structure or to the methods of the present invention without departing from the scope or spirit of the invention. In view of the foregoing, it is intended that the present invention cover modifications and variations of this invention provided they fall within the scope of the following claims and their equivalents.

1. A band pass filter (BPF) for extracting a desired frequency band from an input signal that is represented in a sequence of data stream, comprising:
a shift register for receiving the input signal and synchronously moving the input signal data stream through the shift register so that the input signal goes into an input end and comes out from an output end of the shift register, wherein between the input and output ends of the shift register, a segment of the input data is stored, and as the input signal and time go by, the input signal segment stored in the shift register is sliding through a whole input signal spectrum; and
an arithmetic subtracting unit for obtaining a difference between an input data stored in the output end of the shift register and an input data stored in the input end of the shift register to form an output of the band pass filter.

2. The band pass filter of claim 1, wherein the shift register comprises a plurality of registers that are coupled in cascade to form a serial-in shift register that has a data input end and a data output end, and receives an input signal from the data input end register.

3. The band pass filter of claim 1, wherein the means for synchronously moving the input signal data stream through the shift register is a synchronization clock.

4. The band pass filter of claim 1, wherein the arithmetic subtracting unit subtracts an input data stored in the output end of the shift register from an input data stored in the input end of the shift register to form an output of the band pass filter.

5. The band pass filter of claim 1, wherein the length of the input signal segment stored in the shift register is determined by a sum of one and an integer part of a ratio of a half of a signal sampling rate of the input signal to a desired band pass frequency.

6. The band pass filter of claim 1, wherein each of the registers has a storage capacity of at least one bit of digital data.

7. The band pass filter of claim 1, wherein each of the registers can store a numeric value.

8. The band pass filter of claim 1, wherein the arithmetic subtracting unit comprises an adder and an inverter that is coupled to an input end of the adder.

9. A method of obtaining a desired frequency band from an input signal, which comprises:
receiving the input signal based on a time frame;
marking currently received data as a present reference;
recording a segment of the input signal from the present reference on as the input signal and time go by; and
sequentially reporting a difference between the ends of the recorded input signal segment to obtain an output of the method based on the time frame.

10. The method of claim 9, a length of the memorized input data gment is determined by a ratio of a half of a sampling rate of the input signal to a target desired frequency of the method.

11. The method of claim 9, during a boundary condition, a beginning of the method or an ending of the method, zeros are inserted to both ends of the input data sequence.

12. A method of obtaining a desired frequency band from an input signal, comprising:
providing a number of registers coupled in cascade to form a shift register, having a first register and a last register, wherein each register has a storage capacity of at least one bit; and
computing a difference of contents stored in the first register and the last register to form an output of the method in a clock frame.

13. The method of claim 12, wherein the number of registers is determined by adding one to an integer part of a ratio of a half of the input signal sampling rate to a target desired frequency of the method.

14. The method of claim 12, wherein the difference of contents stored in the first and last registers is calculated by adding a content of the first register and a negative content of the last register to form an output of the method in the clock frame.

15. The method of claim 12, wherein a register in the shift register stores digital data.

16. The method of claim 12, wherein a register in the shift register stores numeric data.

17. The method of claim 9, wherein the method receives the input signal under a synchronization clock.
